(19) United States
(12) Patent Application Publication
(10) Pub. No.: US 2010/0085434 A1
(43) Pub. Date: Apr. 8, 2010

(54) Spectrophotometers and systems therefor

(76) Inventor: Gary Stewart, London (GB)

Correspondence Address: FURGANG & ADWAR, 2 CROSFIELD AVENUE, WEST NYACK, NY, 10994, US

(21) Appl. No.: 12/072,920

(22) Filed: Feb. 27, 2008

Related U.S. Application Data
(60) Provisional application No. 60/904,121, filed on Feb. 28, 2007.

(51) Int. Cl. H04N 17/02; G01J 3/42; G06K 7/00

(52) U.S. Cl. 348/187; 356/319; 382/312; 348/E17.001

(57) ABSTRACT

A handheld device and system ins disclosed in which the device has a wide reading head with a narrow optical slot. The reader is used to read color patches on a target or the color output of a printer or other color reproducing device in which the colors to be measured are presented as a number of patches on a target. The light from the sensor is collimated and diffracted and focused onto a sensor for providing electrical signals indicative of the sensed patch. Repeated images of each test patch are taken and sent to the sensor. The output of the sensor is computed by on board electronics and an external computer to determine each color being measured.

As indicated, light passes through a slot in the handheld device, is collimated and passed through a diffraction grating or prism so as to split the light into its spectral components and its position of its pixels with respect to the slot. The sensor is of the type found in a digital camera or similar means. Thus, the sensor provides signals which provide the spatial component in one direction, the spectral component in the other, and the intensity.

Multiple images are taken of each colored patch. To calibrate the handheld device, the system calculates the spectral values and position of each pixel of a single-colored patch, converting these values into a grey scale and calculating the intensity and density of the light. This is then compared with pre-stored indicia to determine the accurate intensity level. A fully calibrated reader is then used to adjust the output of a color reproducing device, such as a color printer. It performs the same tasks of reading from the color target taken from the color reproducing device and matches the reflected output against stored values and calculates the provided signals to provide control signals to adjust the color reproducing device.

### CROSS-REFERENCE TO RELATED APPLICATION

This application is based upon and seeks the benefit of Provisional Application Ser. No. 60/904,121, filed Feb. 28, 2007, now pending in accordance with 35 U.S.C. §119(e).

### BACKGROUND

1. Field of the Invention

The devices and systems described relates to spectrophotometers and systems for using same.

2. Description of Related Art

Devices used to measure and adjust the color reproducing characteristics of, for example, a printer, are typically calibrated at a factory or similar location. The devices are then brought to the operating site. Over any period of time, experience has shown that these devices will lose their calibration and yet continue to be used to adjust printers or other color reproducing devices and systems. Additionally, these devices, when used to read the output of such devices as printers are inherently slow and inaccurate.

Many prior art instruments use a circular light source at 45° to the object being read and read in the middle of this circle at 0° degrees. The geometry of the prior art devices makes quite a difference to the resulting reading characteristics although these devices meet ISO specification. These readings will vary from instrument to instrument for the same colors. Variations in reading are also influenced by the finish surface of the substrate (e.g., matte or gloss), the media, and ink pigments.

### BRIEF SUMMARY OF THE DEVICE AND SYSTEM

Described is a spectrophotometer for measurement of light which is of the type used to adjust color calibration of color correcting or color reproducing devices. In devices of this nature, light is reflected from more than one point on a target and in which the target may have thereon one or more colors arranged in a pattern or patterns. The spectrophotometer comprises an opening through which passes the light reflected from the target. There are also provided means for receiving and collimating the reflected light, means for diffracting the collimated light, and means responsive to the diffracted light for producing signals indicative thereof.

Also described is a spectrophotometer of the type used in calibrating a color reproducing device and wherein the spectrophotometer reads light reflected from an illuminated target. The spectrophotometer comprises means for providing a predetermined area on the target from which reflected light is received and passed. There are also means for collimating light for receiving and collimating light reflected from the target, means capable of diffracting light for receiving and diffracting the collimated light, and means for converting diffracted light into electrical signals for receiving and responding to the collimated light for producing electrical signals indicative of predetermined components of the reflected light.

Further described is the method of calibration of a reader used for calibrating color reproducing devices in which the reader analyzes light reflected from a target, comprising: collimating the reflected light; diffracting the collimated light; sensing the collimated light with a sensor; and providing electrical signals from the sensor, responding to the received collimated light, indicative of the position of the colored patterns in the illuminated target, the amplitude of the reflected light, and the spectrum of the light at each point of the illuminated target.

Further described is the method of calibrating color reproducing devices, comprising: illuminating a target with a known source of light; providing the target with a number of predetermined separately colored patches; receiving the light reflected from the target into the reader; reading the patches though individual readings of predetermined spots on the target; counting the number of patches, exposures, and pixels for each patch; registering the number counted in a separate counter for patches, exposures and pixels read; causing the reader to take a predetermined number of images of the patches at predetermined intervals so as to create sets of images of each read spot; storing the number of sets and the total number of all images of each patch in a database; reading the signals so as to identify the pixels in each image of each predetermined set; calculating an average of the signal; storing the average value of the output signal representative of each pixel in each set; indicating, upon completion of the storing of the average value, that a predetermined number of patches have been read; storing all images; reading the next patch; comparing the number of stored patches and exposures against predetermined stored values; determining from the comparison if all patches have been read; determining if all predetermined values of a patch have been read; pausing the system to await illumination of the next patch; reading the next patch; incrementing the reading to the next exposure if the full number of predetermined exposures for a patch has not be reached; storing the number of pixels stored for each patch; resetting the counter counting the number of pixels upon the counter reaching a predetermined number of pixels per patch; storing each pixel read; counting the number of pixels stored; turning the pixel counter to zero upon reaching the predetermined number of pixels; waiting for the means of illumination to be turned off; and waiting for the means of illumination to be turned on to initiate a new reading.

Yet another method is described for of determining the density of test patches to establish the accuracy of color reproduction by the color reproduction device, comprising: taking a predetermined amount of images of a patch; storing each image, pixel by pixel of the patch according to a corresponding grey scale; determining the range of densities of the images of the patch; plotting the range of densities along a virtual Y axis; plotting the range of intensity of each pixel of a stored patch along a virtual X axis; processing a new image of a patch, one pixel at a time; plotting the intensity of the image on the virtual X axis at a point A; plotting the density of the image along a virtual Y axis; plotting a predetermined number of points on the X axis on either side of the intensity A; calculating a virtual vertical line from the X axis located between the two points on either side of A; and determining the density of the pixel from the intersection of the vertical line with the plotted intensity against density.

Still another described method for calibrating a color reproducing device, comprising: passing a reader over an image against which the color reproducing device is to be calibrated; counting, from zero, each image; counting, from zero, each pixel of each image; counting pixels until a predetermined number is reached; proceeding to the next pixel; determining which images are within a predetermined range; providing the number of the exposure and the number of pixels associated with that exposure according to the formula: calimage[i,exp,k]>i/p image and i/p image>calimage[i+1,exp,k]? where: calimage (i,j,k)=the previously stored calibration image; exp=the exposure number of the stored pixel; i/p Image=the pixel of the inputted image; i=the calibration image number; Opval[k]=the resultant image pixel; k=the count by the pixel counter; and interpolating a point A between [i,exp,k]>i/p image and i/p image>calimage[i+1,exp,k].

### BRIEF DESCRIPTION OF THE SEVERAL VIEWS OF THE DRAWINGS

The devices and systems described in the drawings in which:

FIG. 1 is a general schematic representation of the device;

FIG. 2 is a top plan view of the device;

FIG. 3 is a bottom plan view of the device;

FIG. 4 is a partial diagrammatic section of the device of FIGS. 2 and 3 taken along line 4-4 and looking in the direction of the arrows with the upper housing removed;

FIG. 5 is an exploded diagrammatic view of the reader of FIG. 4;

FIG. 6 is a perspective view of the device of FIGS. 2-5 with the upper housing removed;

FIG. 7 is a schematic view of the operation of the reader;

FIG. 8 is a diagrammatic representation of the processing of the output of the reader;

FIGS. 9a and 9b are examples of image outputs as read by the reader in a number of different positions;

FIG. 10 is a system flow diagram of the steps of calibration of the system;

FIG. 11 is an example of a graphing of the density of a read pixel;

FIG. 12 is a system flow diagram of the reading of an image;

FIG. 13 is a schematic representation of an alternative means of illuminating a target; and

FIG. 14 is a schematic representation of yet another alternative means of illuminating a target of FIG. 13.

### DETAILED DESCRIPTION OF THE INVENTION

This device and system relates to electro-optical devices for reading the spectral characteristics of a target.

Provided is a scanning spectrophotometer which may comprise a means for illuminating a target (such means may be LEDs or any other well-known means). A ‘target’ is any indicia that is disposed within any illuminated area from which reflected light may be analyzed. Because of it characteristics, this device has the capability of reading a target having either a single color or multiple colors (which are proximate to each other).

Reading of the spectral value of the colors of the target is accomplished by using a scanning function which operates across substantially all of the illuminated area of the target. By moving the device in a forward or reverse direction with respect to a target, multiple groups of adjacent colors can be substantially simultaneously read. As a consequence it is possible for the device to be handheld. With this movement, the device, in effect, scans colors in two directions, one substantially perpendicular to the other, at the same time, at great speed, and with accuracy. The device may be mounted onto various types of fixed or moving machinery (i.e., not hand held), and conversely, the target may then be moved past a means for illuminating a predetermined portion of the target.

This device and system, which will be more fully described below, may be considered in general terms as comprising a device having a wide reading head for receiving light reflected from a target. Light passing into the device may be collimated and passed through a diffraction grating or prism to split the light into its spectral components. This light is then focused onto an imaging sensor, commonly called an image array, such as, for example, of the type found in a digital camera or similar means (referred to hereafter as an “image sensor”), thus providing a spatial component in one direction and a spectral component in the other. The image sensor can measure the quantity of light at each point with the spectrum being spread in one dimension and the spatial position of the target being viewed being spread in the other dimension. Thus, the signals are indicative of the spectral intensity, diffraction deviation, and intensity of the diffracted light as the location of each measured point of the area of the target from which the reflected light is received.

The device described here may create the effect of a multiplicity of reading heads in a line but with a resulting very fine resolution. In this way, very small segments of a target (e.g. a patch) may be subject to separate readings at one time. The effective reading of the patches of an illuminated area of a target at a fine resolution provides three dimensional information which comprises the predetermined illumination width of the target, the amplitude of the light read, and the spectrum of the light. As a consequence, this device may be pushed over an array of target patches to accurately and quickly read the color information. This may be achieved by illuminating a patch on a target and passing the reflected light into the reader and onto a diffraction grating where the white light may be split into its spectral components. A third dimension is added to the usual two dimensions comprising the position of the patch on the illuminated target thereby providing the capability of having a wide reading head. This permits the device to be moved quickly and manually over an image. Multiple exposures are taken from the image sensor. This allows a much higher dynamic range than found in prior art devices. To do so the device reads a number of calibration levels and these exposures may thereafter be ‘knit’ together. While prior art devices are known to read a 3 millimeter section, the device disclosed may read in 0.3 millimeter sections continuously across the width of the read slot. This is accomplished by, as indicated, projecting the image through a diffraction grating and the resulting dispersed image onto an image sensor chip.

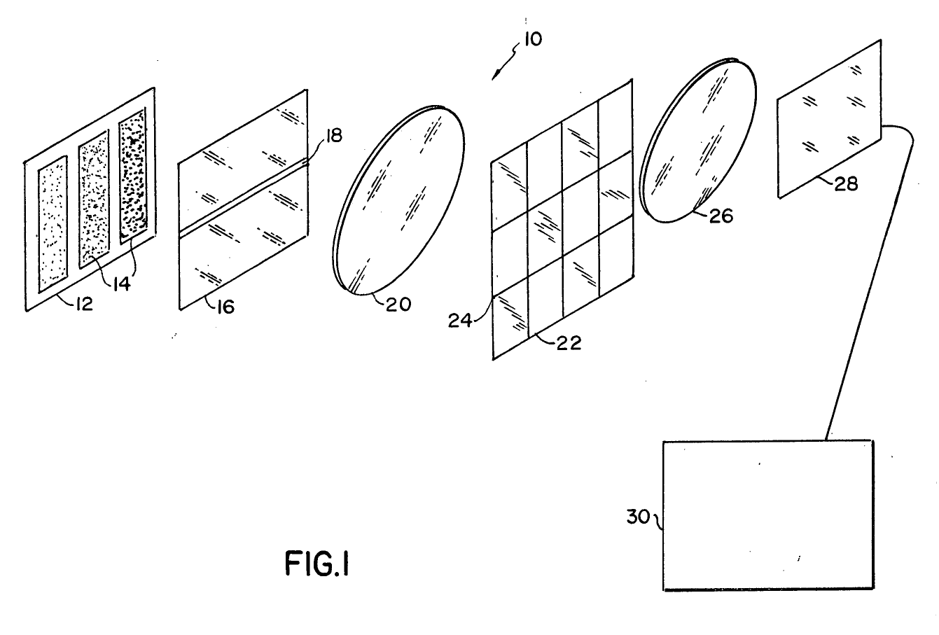

Turning to the drawings, the operation of the device 10 may be explained schematically (FIG. 1) in which a target 12 may be made up of a number of different colored areas 14. An opaque plate 16 may be light absorbent and have a narrow, transparent slot 18.

Alternatively, the target 12′ may be illuminated without the use of a slot (FIG. 13). In this example, the illuminant (e.g., a bank of LEDs (not shown)) generally indicated as a light source 250 may be located at the focal point of a lens 252 disposed in a housing 254 of a reader. The target 12′ is illuminated in a predetermined area 256. The rays of light 258 may be, therefore, reflected off of the target 12′ as at 260. Yet another means for illumination may be provided (FIG. 14). A source of illumination, for example a filament bulb 262 may have its light focused in a predetermined pattern (shown as a rectangle 264) by a bar lens 268.

The slot 18 provides a predetermined area defined by the physical shape of the slot and the target is illuminated, as described below, by a source of illumination projecting through the slot which is, in turn, reflected back through the slot for being analyzed. In the other two examples (FIGS. 13, 14) the means of illumination is focused on the target so as to define a virtual slot. The reader need not have a predetermined defined opening.

Under the device and system described below, the light reflected from the target is first processed by means for collimating the light, such as an optical collimator, e.g., an optical lens 20, and then projected on to a means for diffracting the light (e.g., a transmission diffraction grating 22 which may be orientated with its grating lines 24 parallel to the slot 18). The light passing through the grating 22 and be diffracted at angles relative to its wavelengths, as is well known. A lens 26 may focus this light onto an imaging sensor 28. The sensor 28 may convert the light into electrical charges to thereby act as would a sensor in a digital camera or similar device. The image striking the image sensor 28 comprises spectral information of a point within the slot 18 in one plane. The image also comprises spectral information of points across the slot 18 which thereby provides spatial information in another plane. The magnitude of each point of the spectrum read by the sensor causes the sensor to provide signals which may be fed either through well known circuitry in the reader or located in a CPU 30. The CPU 30 converts this data into standard printing measurements such as CIELab for all of the points along the length of the slot 18.

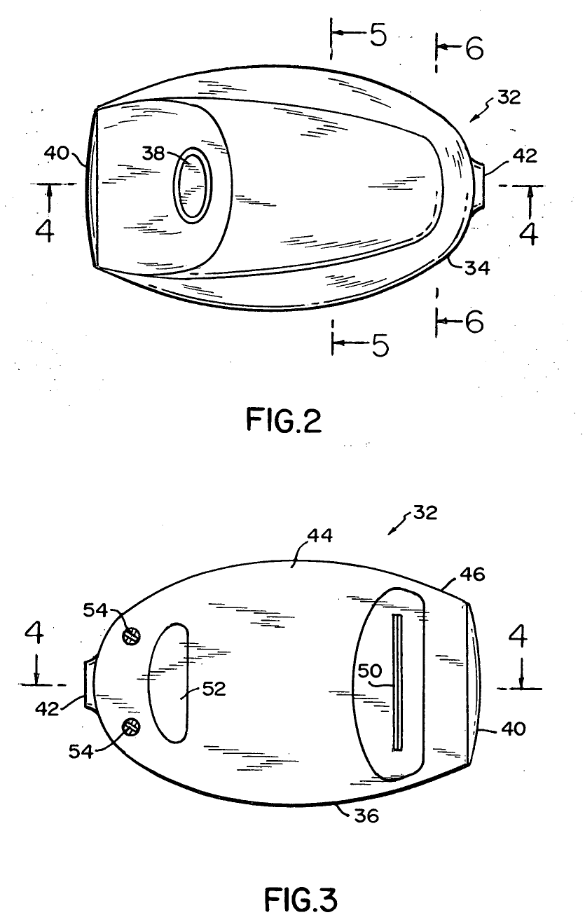

Turning to a more detailed example, this device may comprise a housing 32 (FIGS. 2 and 3) which may have a convenient shape for being comfortably held in the hand, such as that of a computer mouse. The housing 32 may comprise an upper housing 34 joined to a lower housing 36 and may be made of any structural material, such as plastic or metal. The upper and lower housings 34, 36 may be joined to one another as is well known in the art. Centrally disposed in and movable with respect to the upper housing 34 may be a pushbutton 38 which may be similarly constructed of plastic or metal. As with a computer mouse, the housing 32 may have leading and trailing edges 40, 42 and a planar bottom surface 44. A reading housing 46 (FIG. 3) may comprise a regular geometrically shaped housing, as for example an oval (as shown) or any other convenient shape, with an outer surface 48 coplanar with the bottom surface 44 of the lower housing 36. The leading edge 40 of the housing 32 may have any convenient shape and, as shown, may be substantially linear. The reading housing 46 may be joined to the overall housing 32 in an aperture of the same shape and have therein a slot 50. The slot 50 may be conveniently positioned within the reading housing 46 as, for example, substantially parallel to the leading edge 40. The slot 50 may have a substantially rectangular shape. A battery compartment may be closed by a removable cover 52 with the surface thereof coplanar with the remainder of the bottom surface 44 of the lower housing 36. The means for releasably closing the upper and lower housings 34, 36 may be secured to one another by any known means, including two phillips head screws 54.

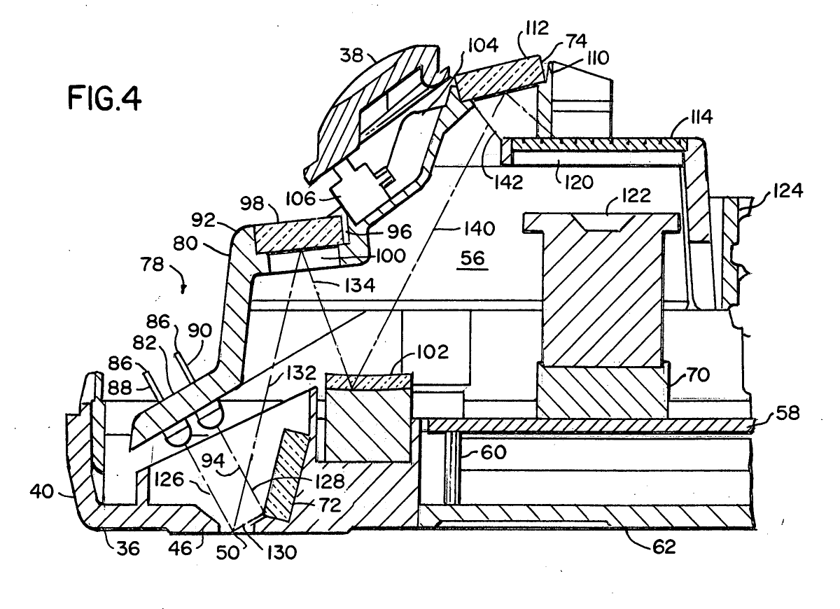

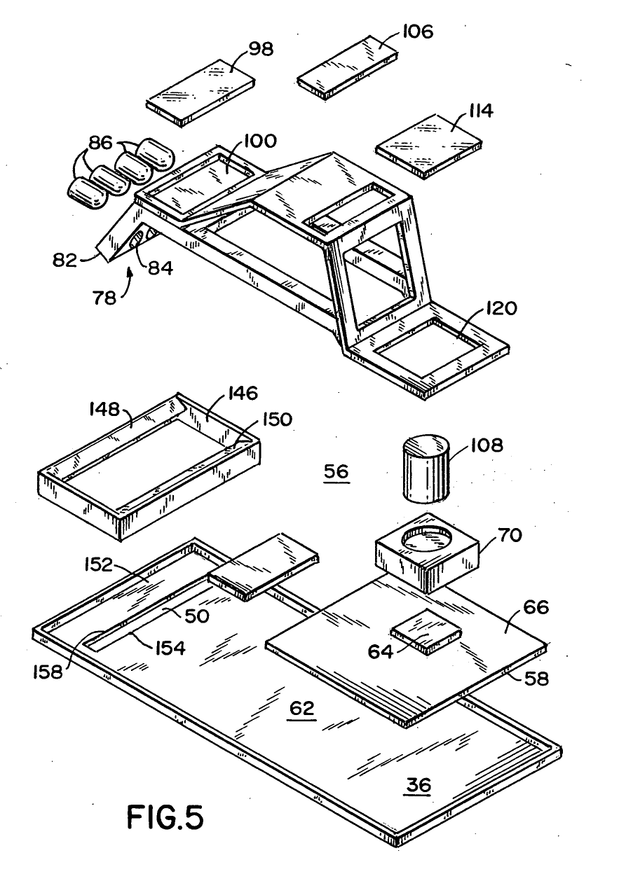

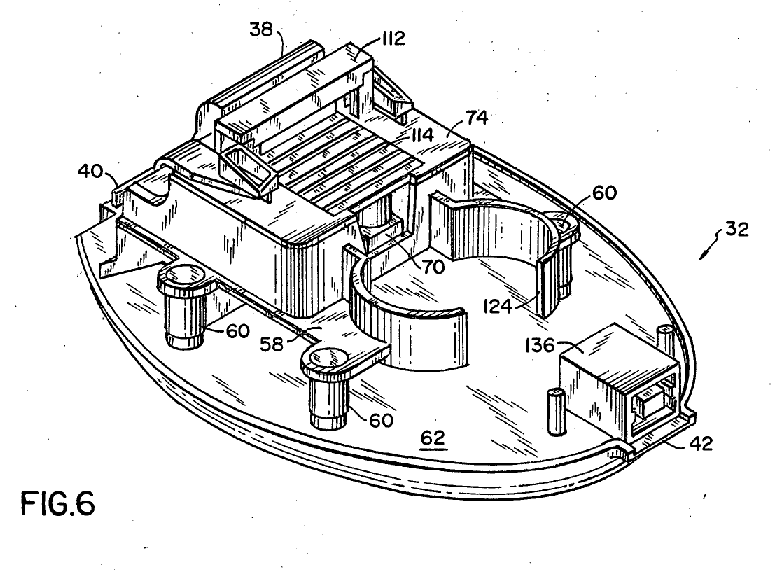

The housing 32 has an interior volume 56 within which may be disposed the interrelated parts making up the operating reader (FIGS. 4-6). A printed circuit board 58 (FIG. 5) may extend parallel the bottom wall 62 of the lower housing 36 and secured thereto by vertical posts 60 in a manner well known in the art. An image sensor (i.e., an image sensing array or the like) 64 may be secured to the upper horizontal surface 66 of the printed circuit board 58 and operably interconnect with the electronics on the circuit board 58 in a manner well known in the art. Any suitable image sensor chip or sensing sensor array 64 may be used, such as CMOS a LUPA 300 manufactured by Cypress Semiconductor Corporation of 198 Champion Court, San Jose, Calif. 95134. A lens mount 70, of a well known type, may be disposed over the chip and secured to the upper surface printed circuit. A typical lens, which may be, for example, a camera lens mount, for example a SUNEX CM 001 threaded tube 108 may be secured to the lens mount 70 by the usual means of interconnection.

A first planar mirror 72 may be fixedly attached to the lower housing 36 as by an adhesive or similar attaching means and disposed proximate the slot 50 and disposed at an acute angle to the vertical as more fully explained below. A generally rectangular support housing 74 may have an open end disposed on the printed circuit board 58, the printed circuit board 58 supporting the vertical side walls 76 of the support housing 74. The support housing 74 may also be viewed as having a complex generally upside down U-shape (FIG. 5), with a leg-side 78 which is closest to the leading edge 40 of the housing 32 having a generally L-shape. One leg 80 of the L leg 78 is vertical and the lower lateral leg 82 extends at an acute angle to the horizontal passing through the juncture of the legs 80, 82. The lateral leg 82 may have therein a multiplicity of apertures 84. LEDs 86 may be secured into each of the apertures 84 in a manner well known in the art and positioned so that light from the LEDs will pass through the slot 50 as more fully explained below.

The LEDs 86 may be arranged in one or more rows. Disclosed here are two rows 88 and 90 of narrow angled broad spectrum white LEDs. Any suitable LED may be used, such as 3 mm white LED NSPW300BS manufactured by Nichia Corporation of Japan.

Extending from the upper end 92 of the vertical leg 80 of the L-shaped support 78 may be a horizontal wall 94. The horizontal wall 94 may have therein a recess 96 for receiving and holding a second planar mirror 98. An aperture 100 in the horizontal wall 94 permits light to pass through the support housing 74 and be reflected by the second planar mirror 98. Supported by the lower housing 36 may be a concave mirror 102.

The pushbutton 38 is resiliently secured to the support housing 74 as by a living hinge 104. The button 38 is so positioned as to be in registry with the upper housing 34 (FIGS. 2 and 4). The end of the pushbutton 38 is so disposed as to releasably engage an electric switch 106. The support housing 74 extends within the housing 32 and at an acute angle with respect to the horizontal and has therein a recess 110 for receiving and holding a third planar mirror 112. An aperture 116 is so positioned as to allow light inside the housing to be reflected off of the planar mirror 112. Beneath the third planar mirror 112 and horizontally secured to a recess 118 in the support housing 74 may be a diffraction grating 114. An aperture 120 in the support housing 74 permits light passing through the grating 114 to pass to a camera lens 122 such as a SUNEX DSL115A-NIR to focus received light onto the chip sensor 64.

The reading device may be provided with a battery holder 124 to receive batteries (not shown) to power the reader. Alternatively, a USB socket 136 may be used to provide power to the reader as well as communicate with a computer (not shown).

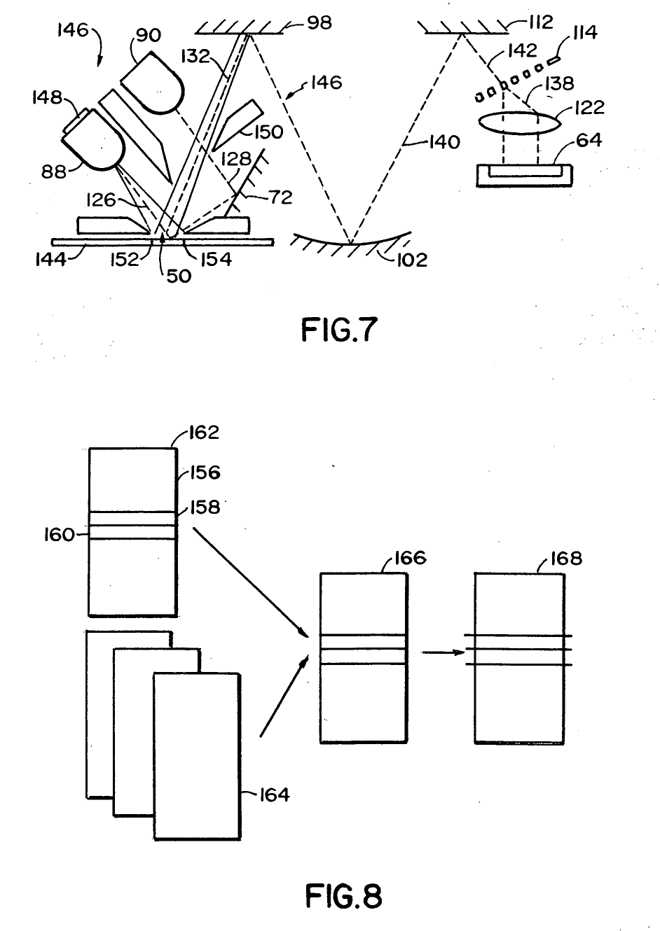

The slot 50 may have any acceptable shape. As disclosed, the slot 50 is rectangular with the longer opposed sides 152, 154 of the slot 50 being substantially parallel to the two rows of LEDs 88, 90. It is desirable to read light reflected off of a target and to reduce or eliminate light dispersed off the opposed edges 152, 154 of the slot 50 and into the light reading path. To do this a stationery optical shuttering 146 (FIGS. 5 and 7), of a type well known in the art, may be disposed so as to block undesired reflected light as more fully described below. The optical shuttering may comprise two optical shutters 148, 150, each disposed parallel the sides 152, 154 of the slot 50. The support for the optical shuttering 146 may be disposed upon the bottom wall 62, about the slot 50 and aligned with the first row 88 of LEDs 86 so that the lower shutter 148 inhibits light from the LEDs 86 reflected off of one of the slot edges 152 and the second shutter 150 inhibits light reflected off the second edge 154 of the LEDs 86.

While the device as described uses a diffraction grating, it is well known that the light may be passed through optics, such as lenses and/or mirrors and also focused on an sensor, without the use of a diffraction grating. It is also well known to use different combinations of lenses and mirrors to focus light.

In operation, a target 144 (FIG. 7) is moved with respect to the slot 50. The user depresses the pushbutton 38 which, in turn, closes the switch 106. The closing of the switch 106 causes current to be delivered to the LEDs 86. The light from one row 88 will pass directly to the slot 50 (line 126). Light from the second row of LEDs 90 strikes the first planar mirror 72 (line 128). The mirror 72 may be disposed at a predetermined angle such that the light striking the mirror 128 is reflected to the slot 50 (line 130).

The light passing through the slot 50 and striking the target 144 (FIGS. 4, 7) may then be reflected to the second planar mirror 98 (the light path is shown diagrammatically by line 132). The second planar mirror 98 may be disposed at an acute angle with respect to a horizontal plane so as to reflect the received light to the concave mirror 102, shown by line 134. Light is then reflected by the concave mirror 102 to the third planar mirror 112 to the diffraction grating, shown by line 140. The concave mirror 102 may act as a collimator. The collimated light may then be reflected from the third planar mirror 112 to the diffraction grating 114 (line 142). The diffracted light 138 (FIG. 7) may then be received by the lens 122. The lens 122 may focus the diffracted light 156 onto the chip 64. The chip 64 may then convert the light into electrical signals. These signals may then be processed by electronics on the printed circuit board 58 or in an external CPU or both in a manner well known in the art. Signals processed on the circuit board 59 may then be sent, via the USB socket 136 and a line out (not shown), to the CPU for further processing in a manner referred to above and more fully discussed below and power may be received in a like manner. Performance is found to improve the narrower in width the slot 50 and the nearer the LED lights 86 are to pure white.

To read a picture, the reader 10 may be disposed over a target. It has been found that the sensitivity of the image sensor chip does not remain constant and must be continually calibrated. For example, the output of the reading may vary because of such factors as component variations and the influence of ambient dust. The collimated and spectral image generated 156 may, as in this example, comprise two colors 158 and 160 which appears on a pale background 162. This image is presented in a gradation from grey to black. As shown, the colors 158, 160 are shown perpendicular to the width of the slot 50 and may comprise blue 158 and red 160. For the top, blue stripe 158 provides the known pattern of grey, left, to black, right. The bottom red stripe 160 provides the pattern from black, left, to grey, right. The brightness of an image is a function of the specific color. The system (not shown) may have stored in a database calibration images 164, and diagrammatically indicated, containing readings of known colors as previously read by the reader 10. Each pixel of these patches has a known reflectance. A reflectance picture 166 is generated in the system by choosing, on a pvalue by interpolating above and below the two selected images. The system will then scan the images formed 168 from top to bottom or vice versa and identify boundaries 170 between the patterns. By this means the colors in an image have been identified by their pixel and may be read by the system with each pixel being the reflectance at a particular point in the spectrum.

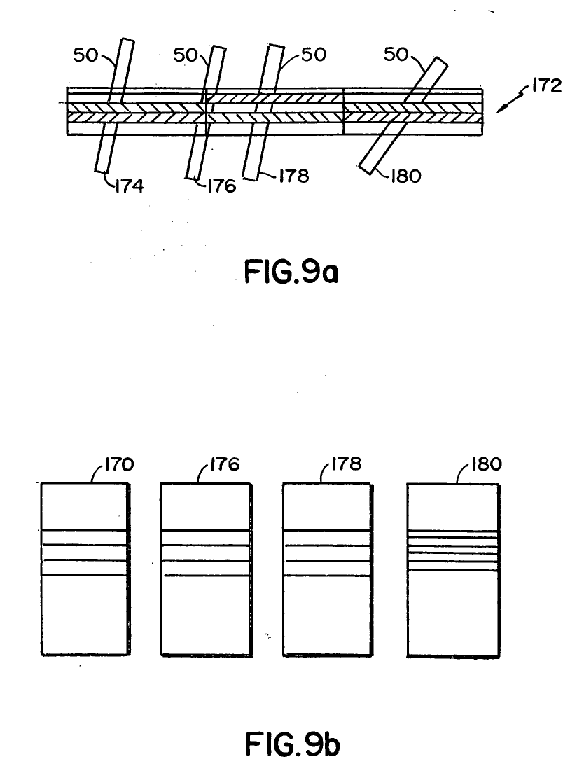

As the reader 10 is moved with respect to a target, the output will change. Thus, in this example, the slot 50 is shown in successive positions, passing over stripes of colors 172 (FIGS. 9a, 9b). The positions of the slot 174-180 (FIG. 9a) are coordinated with the resulting processed image (FIG. 9b) (174-180). The images produced at the first and third positions 174, 178 will provide clear boundaries and the image repeats throughout the time the slot is over the constant part of each set of stripes 172. In the second position 176, the image will be spectrally blurred because part of the slot 50 will be over one set of colors and part will be over the next set. The average of the two will provide an intermediate range of colors. The system will, therefore, compare these images to stored patches by looking for similar adjacent read images on a time basis and the intermediate range images will be discarded.

The system of this device is used to calibrate the reader 10. The calibrated reader 10 of the system and device can then measure colors provided by a color producing device, such as a printer. The calibrated reader is then used to read the color output of such devices as printers, painting machines, and the like. If the color output differs from that expected by the reader and the system, the color output is then corrected.

A color reproducing device, such as a printer produces a colored area. One of the properties of that colored area can be defined as the color. (The printed area—in the case of printers—comprises gloss, absorption and scatter and the like which are not considered by the device and system). Color may be defined as a graph of reflected intensity against the wavelength, as is well known. This information may be compressed into less accurate, but more user friendly descriptions, such as RGB, Lab, etc. One of the commonly used descriptions is density and this usually comprises red, green, blue, and black and the contribution of each part of the spectrum to calculating the density is specified by ISO. Density is important in printing. Density provides the feedback that is used to control the press as it correlates to the thickness of the ink layer being put down and the four colors commonly used. Thus, this device uses density, because the intensity of a color is meaningless without defining the color.

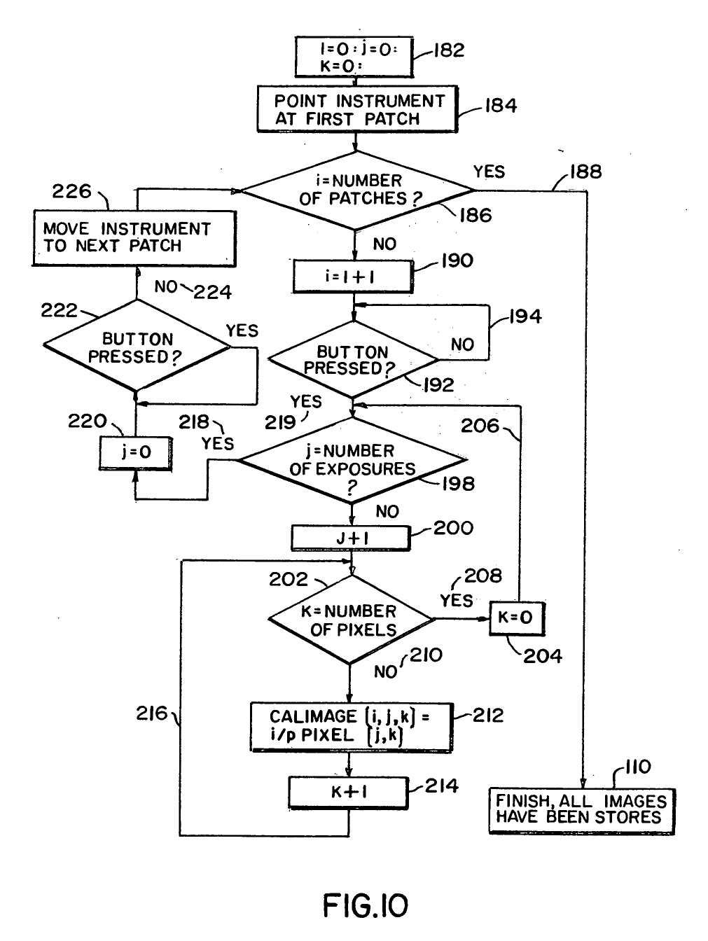

Turning first to the calibration of the system (FIG. 10, which provides a logical flow in which reference numbers refer to the flow diagram), this is performed by passing the reader 10 over known patches. As the patches are passed by the reader 10, the system keeps count of the number of patches (i), the number of exposures (j), and the number of pixels (k) 184.

Pressing the button 38 causes the LEDs 86 to illuminate the patches. The system, as shown in FIG. 10, takes and stores one image per patch.

As one alternative, the system 182 may optionally take a predetermined number of images of an individual patch. Thus, for example, the system may take a set of ten images at 1 ms, a set of ten images at 3 ms, a set of ten images at 5 ms, and a set of ten images at 8 ms. The number of images in each set and the times between sets is elective and predetermined. The system stores the number of sets and the total number of all of the images of the patch that have actually been taken. Thus, in this example, the system records that it has taken ten sets of the images and, therefore, a total of forty images. When the total predetermined number of sets of images and the total number images are reached, the system now proceeds to average the pixels.

As is well known, each pixel in a known image has a known location. It is also well known that a sensor (e.g., CMOS or CCD) reading a pixel, outputs a signal which is representative of the intensity of that pixel.

The system of this device may read the signal from the sensor for a known pixel in each image of a predetermined set and calculates the average of that signal and stores that average. In this way, the system averages out any general noise that is found in that pixel. When all calculations of the images of a patch are completed, the system, in this example, has stored the average value of the output signal of each pixel per set. This results in four averaged images.

When the total predetermined number of patches have been read, the system indicates YES 188 that it has now stored all images 190.

The system, having read one patch, moves on to the next patch and records the number of patches read 191 and, if appropriate, counts the number of exposures (j) for each patch. The system compares these values against predetermined values to obtain an indication that all patches have or have not been read.

Once the system has counted all of the predetermined values indicating that a patch has been read, the system looks to see if the pushbutton 38 has been pressed 192 so it may advance to the next patch. If NO 194, the system pauses and waits for the pressing of the pushbutton. Once the button 38 is pressed by the operator, YES 196, the previous steps are repeated for the next patch and stored.

The system next determines if it has stored the total number of exposures (j) for each patch 198. If the full number of exposures for each patch has not been reached NO 194, the counter 200 is incremented to the next exposure by j+1. The system then stores 202 the total number of pixels (k) stored for each patch. If the count indicates that the total number of pixels per patch has been reached (YES 208) the counter 204 is reset to 0 and the system advances (line 206) for the next exposure. As the count proceeds, each pixel is stored 212 one at a time and a pixel counter 214 records the number of pixels stored and passes that information 216 to the store step 202 where, when the predetermined number pixels are reached, the systems issues the YES 208.

When the predetermined number of exposures per patch has been reached 198, the system indicates YES 218, the exposure number (j) is returned to zero 220. The system waits for the release of the pushbutton 222. If the button has yet to be released YES 223 the system pauses. Once the pushbutton is released, NO 224, the system is ready for the operator to advance 226 to the next patch 186 (at which point it will cycle back through the steps set forth in connection 186, 191, 192, awaiting for the pushbutton to be pressed.

The next step is to mathematically determine the density of a newly read image to assure that the printer or similar device is providing an accurate reproduction. This is done through the steps of interpolation as explained by a graph (FIG. 11). In practice, the step of interpolation is performed by the computational steps of the system.

With all patches read, the system has stored all of the images for calibrating the reader 10. The stored images can be any color. In this example, various levels of grey may be used.

The density of all of the calibration patches is provided to the system. The range of these densities is provided along the Y axis of the graph. The X axis is the range of intensity of any pixel that may have been stored during the calibration process above. The plotted points on the graph are the points within the stored calibration file upon completion of the calibration above. Thus, for example, this graph may be of a pixel taken at 1 ms at location 2,3 of the image of all patches. In this example there are five patches. Thus, the chart shows five plots of the known density (X axis) against the measured intensity (Y axis) of a pixel in a same predetermined location of each patch that has been read.

When a new image is to be read (for example, a color illustration), the entire image is read and then processed one pixel at a time. The read value of the intensity of the pixel is now a known value A which is plotted on the X axis. This A value is, in this example, plotted with three plotted points to the left and two to the right. A line is calculated between the two plotted points that bracket the A value. The calculated intersection of this line defines the density on the X axis.

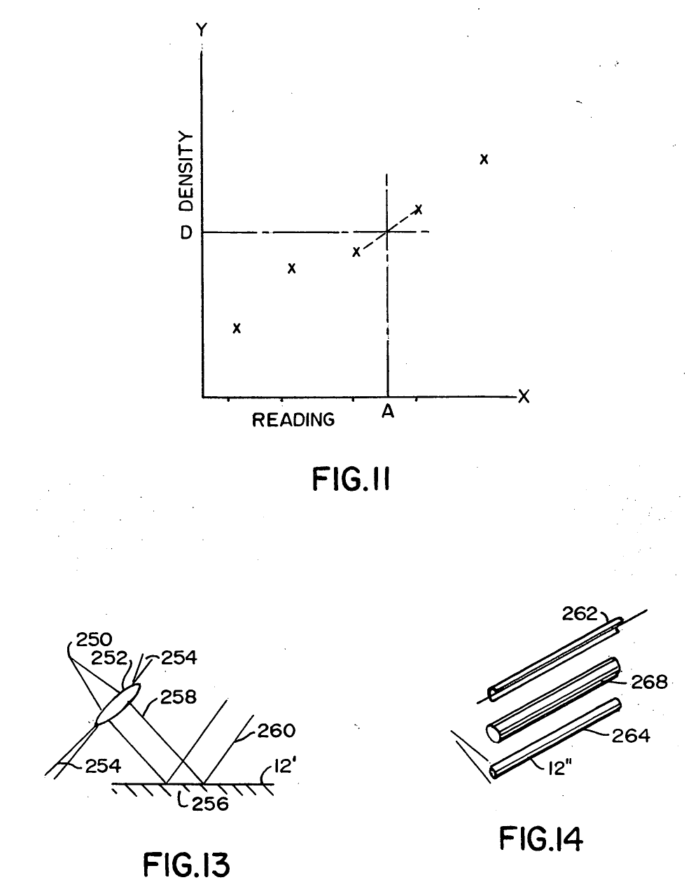

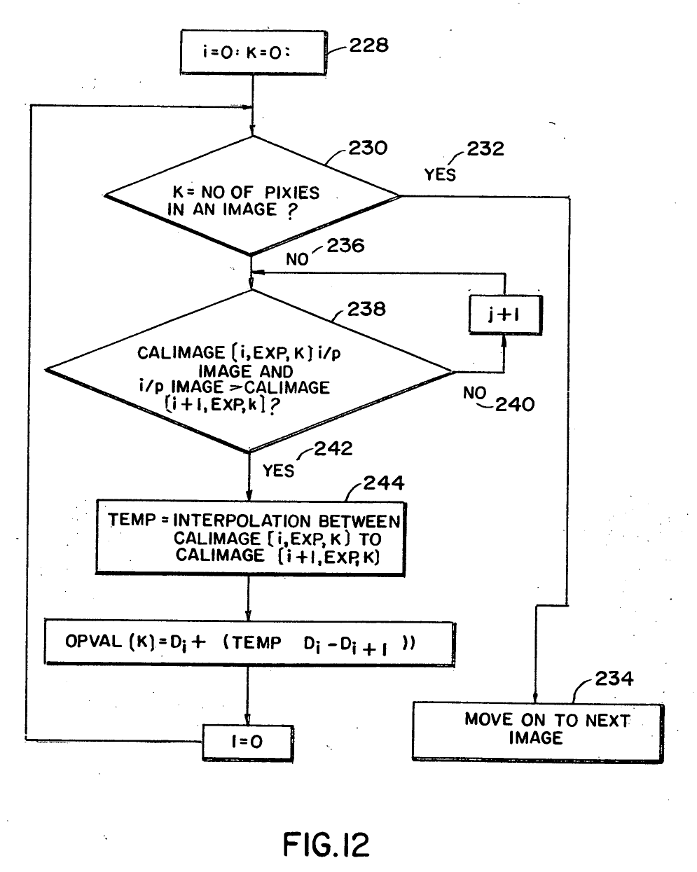

Turning to a flow diagram (FIG. 12), the reader 10 is passed over an image against which the device (e.g., a printer) is to be calibrated so that the output provides an accurate reproduction. The goal is to calculate the image to provide useable information so as to set or reset, in this example, a printer. A counter 228 (FIG. 12) starts the count with the image (i) and pixels (k) at 0 and the counter 230 counts the number of pixels. If the total number of pixels are reached, YES 232, the system then proceeds to the next pixel 234. If not NO 236, the image is not complete. To reduce the amount of stored data, the system decides which exposure is in a useful range. The system provides the exposure number and the pixel number associated with that exposure (abbreviated as calimage[i,exp,k]>i/p image and i/p image>calimage[i+1,exp,k]? 238 where calimage (i,j,k) equals the previously stored calibration image; exp equals the exposure number of the stored pixel; i/p Image equals the pixel of the inputted image; i equals the calibration image number; Opval[k] equals the resultant image pixel; k equals the count by the pixel counter).

As these calculations are made, going up the density scale (FIG. 12) the middle or grey range (i.e., between black and white) will be reached. Thus, for example if the reader is reading a patch, and pixel (p) 20 at an exposure (exp) of 10 ms, the result must be, as shown, between the two plotted points on the graph. Typically, the X axis is a number between 0 and 1024. The density values on the Y axes are density values between 0 and 100. There is a graph calculation for each pixel. The points on the graph are stored points in a database. If the image number is reached (NO 240), the counter (242) advances to the next image. If the two points are found (YES 242) the result is placed in temporary storage 244 and the position is interpolated between the two points on the graph.

As a consequence of the above system, if a file is sent to a printer requesting 1.0 D red but the calibrated reader reads 0.8 D red, the system, in response to this difference, will change the printer output by ordering the printer to, for example, print 1.2 D red instead of 1.0 D red.

Without further analysis, the foregoing will so fully reveal the gist of the present device and system that others can, by applying current knowledge, readily adapt it for various applications without omitting features that, from the standpoint of prior art, fairly constitute essential characteristics of the generic or specific aspects of the device and/or system.

What is claimed is:

1. A spectrophotometer for measurement of light of the type used to adjust color calibration of color correcting or color reproducing devices in which light is reflected from more than one point on a target and in which the target may have thereon one or more colors arranged in a pattern or patterns, the spectrophotometer comprising:
a) an opening through which passes the light reflected from the target;
b) means for receiving and collimating the reflected light;
c) means for diffracting said collimated light; and
d) means responsive to said diffracted light for producing signals indicative thereof.

2. The spectrophotometer of claim 1 further comprises an opaque and absorbent member having an opening through which passes the reflected light.

3. The spectrophotometer of claim 2 wherein said signals are indicative of the spectral intensity, diffraction deviation and intensity of said diffracted light and the location of each measured point of the area of the target from which is provided the reflected light.

4. The spectrophotometer of claim 3 further comprises means for optically focusing said collimated light upon said means responsive to diffracted light for producing signals.

5. The spectrophotometer of claim 4 wherein said means for receiving and diffracting comprises a diffraction grating.

6. The spectrophotometer of claim 5 wherein said means for optically focusing said collimated light comprises at least an optical lens.

7. The spectrophotometer of claim 6 wherein said means responsive to said focused diffracted light further comprises a sensor capable for producing said signals.

8. The spectrophotometer of claim 7 further comprising means for processing said signals into algorithms for adjusting the color measurement and color reproduction devices.

9. The spectrophotometer of claim 8 wherein said means for making calculations comprises a computer.

10. The spectrophotometer of claim 4 wherein said means responsive to said diffracted light comprises optics.

11. The spectrophotometer of claim 7 wherein said optics comprises a combination of mirrors and lenses.

12. The spectrophotometer of claim 3 further comprising means for converting said signals into color measurements.

13. The spectrophotometer of claim 11 said computer converts said signals into color measurements.

14. A spectrophotometer of the type used in calibrating a color reproducing device and wherein the spectrophotometer reads light reflected from an illuminated target, comprising:
a) means for providing a predetermined area on the target from which reflected light is received and passed;
b) means for collimating light for receiving and collimating light reflected from the target;
c) means capable of diffracting light for receiving and diffracting said collimated light; and
d) means for converting diffracted light into electrical signals for receiving and responding to said collimated light for producing electrical signals indicative of predetermined components of the reflected light.

15. The spectrophotometer of claim 14 wherein said means for collimating light comprises an optical lens.

16. The spectrophotometer of claim 14 wherein said means for collimating light comprises a concave mirror.

17. The spectrophotometer of claim 14 wherein said means for diffraction comprises a diffraction grating.

18. The spectrophotometer of claim 14 wherein said means for converting comprises an electrical image sensor.

19. The spectrophotometer of claim 14 further comprises means for transmitting light for transmitting the reflected light to said diffraction grating.

20. The spectrophotometer of claim 19 wherein said means for transmitting light comprises at least one mirror positioned with respect to an opening within said housing so as to effect transmission of the light reflected from the target to said means for diffracting.

21. The spectrophotometer of claim 20 wherein said opening is a non-regular rectangular slot and said mirror is positioned along the longer side of said rectangle.

22. The spectrophotometer of claim 21 where in said means transmitting further comprises second and third mirrors and wherein said first and third mirrors are planar mirrors and said second mirror is concave.

23. The spectrophotometer of claim 22 wherein said means for collimating comprises said second mirror.

24. The spectrophotometer of claim 20 wherein said means for converting light comprises at least an optical lens for focusing said diffracted light and an electrical sensor for converting said collimated and focused light into electrical signals.

25. The spectrophotometer of claim 20 wherein said optical lens is secured proximate said electrical sensor.

26. The spectrophotometer of claim 14 further comprises computational means for converting said electrical signals into an output which is capable of being used to calibrate the color calibration or reproducing devices.

27. The spectrophotometer of claim 26 further comprises two rows of LEDs and two optical shutters disposed between to align the light produced by said LEDs and a fourth planar mirror disposed proximate the opposed longer side of said slot from said LEDs to reflect the light produced by one of said rows of LEDs onto the target; said optical shutters inhibiting aberrant dispersion of light from the edges of said slot.

28. The spectrophotometer of claim 27 further comprises an electrical switch movably secured to said housing for selectively switching on said LEDs.

29. The spectrophotometer of claim 28 wherein said housing comprises a handheld computer mouse-like structure with at least said LEDs, mirrors, diffraction grating, optical mirror, and sensor fixedly secured there within.

30. The method of calibration of a reader used for calibrating color reproducing devices in which the reader analyzes light reflected from a target, comprising:
collimating the reflected light;
diffracting the collimated light;
sensing the collimated light with a sensor; and
providing electrical signals from the sensor, responding to the received collimated light, indicative of the position of the colored patterns in the illuminated target; the amplitude of the reflected light, and the spectrum of the light at each point of the illuminated target.

31. The method of calibration recited in claim 30 further comprising choosing by computation of the signals, pixel by pixel, of the sensed light.

32. The method of calibration recited in claim 31 further comprising computing from the sensed light a reflectance picture of each pixel.

33. The method of calibration recited in claim 32 further comprises mathematically interpolating between two predetermined chosen calibration images;

34. The method of calibration recited in claim 33 further comprises identifying boundaries between colors within the target.

35. The method of calibration recited in claim 34 further comprises successively reading constant colors.

36. The method of calibration recited in claim 35 further comprises passing the reader over adjacent colors on the target.

37. The method of calibration recited in claim 36 further comprises averaging the adjacent color images to provide an intermediate range of colors.

38. The method of calibration recited in claim 37 further comprising storing in a database data representative of images of known colors.

39. The method of calibration recited in claim 38 further comprises comparing the images of the intermediate range of colors of the read target on a time basis with the information of the color images stored in the database.

40. The method of calibration recited in claim 39 further comprises discarding the intermediate range images.

41. The method of calibration recited in claim 40 further comprises adjusting the reader to provide output results matching the stored images.

42. The method of calibration recited in claim 41 further comprises receiving the reflected light through a slot in a reader housing; defining the area from which the reflected light is received by the dimensions of the slot.

43. The method of calibration recited in claim 41 further comprises projecting predetermined illumination from a known source onto the target; defining with the projection a virtual slot; receiving the reflected light into a reader housing; defining the area from which the reflected light is received by the projected virtual slot.

44. The method of calibrating color reproducing devices, comprising:
illuminating a target with a known source of light;
providing the target with a number of predetermined separately colored patches;
receiving the light reflected from the target into the reader;
reading the patches though individual readings of predetermined spots on the target;
counting the number of patches, exposures, and pixels for each patch;
registering the number counted in a separate counter for patches, exposures and pixels read;
causing the reader to take a predetermined number of images of the patches at predetermined intervals so as to create sets of images of each read spot;
storing the number of sets and the total number of all images of each patch in a database;
reading the signals so as to identify the pixels in each image of each predetermined set;
calculating an average of the signal;
storing the average value of the output signal representative of each pixel in each set;
indicating, upon completion of the storing of the average value, that a predetermined number of patches have been read;
storing all images;
reading the next patch;
comparing the number of stored patches and exposures against predetermined stored values;
determining from the comparison if all patches have been read;
determining if all predetermined values of a patch have been read;
pausing the system to await illumination of the next patch;
reading the next patch;
incrementing the reading to the next exposure if the full number of predetermined exposures for a patch has not be reached;
storing the number of pixels stored for each patch;
resetting the counter counting the number of pixels upon the counter reaching a predetermined number of pixels per patch;
storing each pixel read;
counting the number of pixels stored;
turning the pixel counter to zero upon reaching the predetermined number of pixels;
waiting for the means of illumination to be turned off; and
waiting for the means of illumination to be turned on to initiate a new reading.

45. The method of calibrating color reproducing devices as recited in claim 44 wherein the step of receiving the reflected light further comprises generating a spectral image of the received light.

46. The method of calibrating color reproducing devices as recited in claim 45 further comprising recording the number of exposures for each patch.

47. The method of calibrating color reproducing devices as recited in claim 45 wherein the step of receiving the reflected light comprises providing a slot through which the target is illuminated and through which reflected light is received.

48. The method of calibrating color reproducing devices as recited in claim 46 wherein the step of receiving the reflected light comprises providing projecting a predetermined pattern of predetermined light upon a target to form a virtual slot.

49. A method of determining the density of test patches to establish the accuracy of color reproduction by the color reproduction device, comprising:
taking a predetermined amount of images of a patch;
storing each image, pixel by pixel of the patch according to a corresponding grey scale;
determining the range of densities of the images of the patch;
plotting the range of densities along a virtual Y axis;
plotting the range of intensity of each pixel of a stored patch along a virtual X axis;
processing a new image of a patch, one pixel at a time;
plotting the intensity of the image on the virtual X axis at a point A;
plotting the density of the image along a virtual Y axis;
plotting a predetermined number of points on the X axis on either side of the intensity A;
calculating a virtual vertical line from the X axis located between the two points on either side of A; and
determining the density of the pixel from the intersection of the vertical line with the plotted intensity against density.

50. The method of calibrating a color reproducing device, comprising:
passing a reader over an image against which the color reproducing device is to be calibrated;
counting, from zero, each image;
counting, from zero, each pixel of each image;
counting pixels until a predetermined number is reached;
proceeding to the next pixel;
determining which images are within a predetermined range;
providing the number of the exposure and the number of pixels associated with that exposure according to the formula:
calimage[i,exp,k]>i/p image and i/p image>calimage[i+1,exp,k]?
where:
calimage(i,j,k)=the previously stored calibration image;
exp=the exposure number of the stored pixel;
i/p Image=the pixel of the inputted image;
i=the calibration image number;
Opval[k]=the resultant image pixel;
k=the count by the pixel counter; and
interpolating a point A between [i,exp,k]>i/p image and i/p image>calimage[i+1,exp,k].

51. The method of calibrating a color reproducing device of claim 50 further comprising:
plotting the intensity of the read density of the measured image on a virtual X axis at a point A;
plotting the demanded density of each image on a virtual Y axis;
plotting a predetermined number of points on the virtual X axis on either side of the measured density at the point A;
calculating a vertical line from the virtual X axis located between two points on either side of point A; and
determining the calibration multiplication from the calculated intersection of the virtual vertical line with the plotted read intensity against demanded density.

52. The method of calibrating a color reproducing device of claim 51 further comprising:
plotting measured density along the virtual X axis as a number between 0 and 1024;
plotting demanded density along the virtual Y axis as a number between 0 and 100;
using predetermined points stored in a database to determine measured against demanded density.
